(19) United States
(12) Patent Application Publication
(10) Pub. No.: US 2010/0097627 A1
(43) Pub. Date: Apr. 22, 2010

(54) DISPLAY CONTROL APPARATUS, IMAGE-FORMING APPARATUS, AND STORING MEDIUM

(75) Inventor: Yoshihiro SEKINE, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/427,299

(22) Filed: Apr. 21, 2009

(30) Foreign Application Priority Data
Oct. 16, 2008 (JP) 2008-267800

(51) Int. Cl. G06K 15/00

(52) U.S. Cl. 358/1.14; 358/1.16

(57) ABSTRACT

A display control apparatus includes: a memory that stores a plurality of units of correspondence information each indicative of a correspondence between a display region of a display for displaying a message, and a type of the message, with at least one of a number, an arrangement, and a size of the display region differing among the plurality of units of correspondence information; a selection unit that selects a unit of correspondence information stored in the memory; and a display controller that, when display of a message is requested, designates a display region corresponding to the type of the message requested to be displayed based on the correspondence information selected by the selection unit, and displays the message requested to be displayed in the designated display region.

### CROSS-REFERENCE TO RELATED APPLICATIONS

This application is based on and claims priority under 35 U.S.C. 119 from Japanese Patent Application No. 2008-267800, which was filed on Oct. 19, 2008.

### BACKGROUND

1. Technical Field

The present invention relates to a display control apparatus, an image-forming apparatus, and a program.

2. Related Art

Technology is known that displays a message informing that there is an error, obstacle, or the like according to a priority.

### SUMMARY

According to an aspect of the invention, there is provided a display control apparatus comprising: a memory that stores a plurality of units of correspondence information each indicative of a correspondence between a display region of a display for displaying a message, and a type of the message, each of the plurality of units of correspondence information having a different condition of at least one of a number, an arrangement, and a size of the display region; a selection unit that selects a unit of correspondence information stored in the memory; and a display controller that, when display of a message is requested, designates a display region corresponding to the type of the message requested to be displayed based on the correspondence information selected by the selection unit, and displays the message requested to be displayed in the designated display.

### BRIEF DESCRIPTION OF THE DRAWINGS

Exemplary embodiments of the present invention will be described in detail based on the following figures, wherein:

FIG. 1 is a block diagram that shows the configuration of an image-forming apparatus according to the present exemplary embodiment;

FIG. 2 illustrates page templates of the above image-forming apparatus;

FIGS. 3A and 3B show examples of tables stored by the above image-forming apparatus;

FIG. 4 shows an example of priority information stored by the above image-forming apparatus;

FIG. 5 shows an example of a message DB stored by the above image-forming apparatus;

FIG. 6 shows the functional configuration of the above image-forming apparatus;

FIG. 7 illustrates example behavior codes used by the above image-forming apparatus;

FIG. 8 is a flowchart that shows an initialization process of the above image-forming apparatus;

FIG. 9 shows an initialization screen displayed by the above image-forming apparatus;

FIG. 10 is a flowchart that shows a message display process of the above image-forming apparatus;

FIGS. 11A and 11B show messages displayed by the above image-forming apparatus;

FIG. 12 is a flowchart that shows a switching process of the above image-forming apparatus;

FIG. 13 shows a display region created by the above image-forming apparatus;

FIG. 14 shows a pop-up display of the above image-forming apparatus; and

FIG. 15 shows a message display when there are multiple display operation units according to a modified example.

### DETAILED DESCRIPTION

Configuration

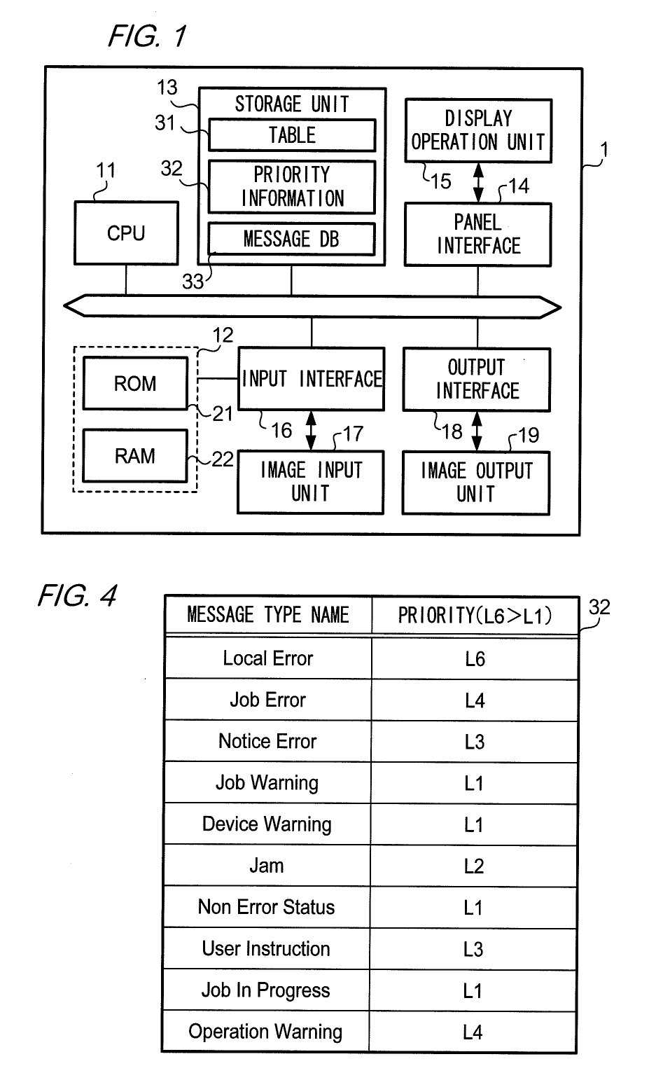

FIG. 1 is a block diagram that shows the configuration of an image-forming apparatus 1 according to this exemplary embodiment. This image-forming apparatus 1 has multiple functions, such as a printer function, a scan function, and a copy function. As shown in FIG. 1, the image-forming apparatus 1 is provided with a CPU 11, a memory 12, a storage unit 13, a panel interface 14, a display operation unit 15, an input interface 16, an image input unit 17, an output interface 18, and an image output unit 19. In this exemplary embodiment, the CPU 11 and the storage unit 13 operate cooperatively to function as a display control apparatus.

The CPU 11 executes programs stored in the memory 12 or the storage unit 13 to control the parts of the image-forming apparatus 1. Thus CPU 11 is an example of a selection unit, a priority acquisition unit, and a display controller. The memory 12 is provided with a ROM (Read Only Memory) 21 where programs and data necessary for startup of the image-forming apparatus 1 are stored, a RAM (Random Access Memory) 22 used as a work region when the CPU 11 executes a program, and so forth. The storage unit 13 is, for example, a hard disk, and other than various programs executed by the CPU 11, stores a table 31, priority information 32, a message database (DB) 33, and so forth. The panel interface 14 is an interface that exchanges data with the display operation unit 15. The display operation unit 15 is, for example, a touch panel, and along with displaying a screen according to control of the CPU 11, inputs an operation signal to the CPU 11 according to operation by a user. The input interface 16 is an interface that exchanges data with the memory 12 and the image input unit 17. The image input unit 17 is a communications unit that performs communications with, for example, a scanner apparatus or an external apparatus, and receives input of image data that expresses a source image. The output interface 18 is an interface that exchanges data with the image output unit 19. The image output unit 19 is a printer apparatus that forms an image by an electrophotograhic method, for example, and outputs an image based on the image data which is input via the image input unit 17 so as to form the image on a paper. In other words, the image output unit 19 has a function of an image-forming unit.

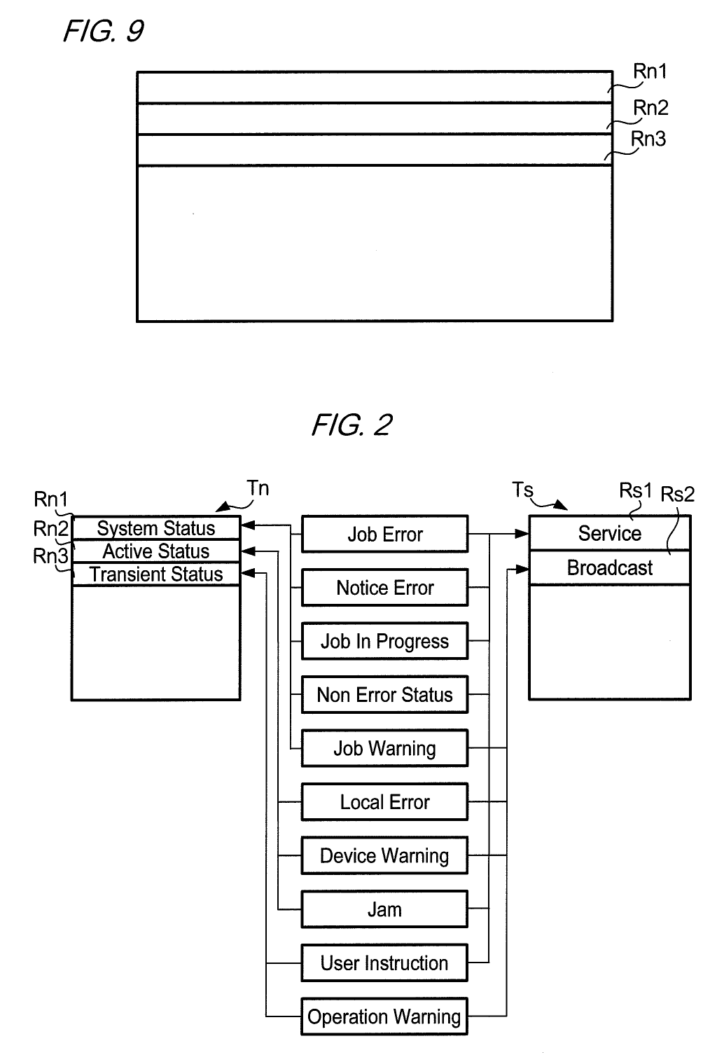

Next is a description of page templates of the screen displayed in the display operation unit 15, with reference to FIG. 2. A normal page template Tn and a simple page template Ts are provided in the image-forming apparatus 1. As shown in FIG. 2, a display region Rn1 with the name ‘System Status’, a display region Rn2 with the name ‘Active Status’, and a display region Rn3 with the name ‘Transient Status’ are provided in the normal page template Tn. The display region Rn1 is a display region where a message related to a process is displayed. The display region Rn2 is a display region where a message related to a device is displayed. The display region Rn3 is a display region where a message related to an operation by the user is displayed. In each of the display regions Rn1 to Rn3, 28 full-width characters are disposed. Also, a display region Rs1 with the name ‘Service’ and a display region Rs2 with the name ‘Broadcast’ are provided in the simple page template Ts. The display region Rs1 is a display region where a message is displayed that accompanies operation of services such as a printer function, a scan function, and a copy function. The display region Rs2 is a display region where a message that does not depend on these specific services is displayed. In the display regions Rs1 and Rs2, 23 full-width characters are disposed. In this way, characters of a larger size than those in the display regions Rn1 to Rn3 of the normal page template Tn are disposed in the display regions Rs1 and Rs2 of the simple page template Ts.

Also, in each display region of the normal page template Tn and the simple page template Ts, a message type to which the displayed message belongs is assigned. In the example shown in FIG. 2, message types ‘Job Error’, ‘Notice Error’, ‘Job In Progress’, ‘Non Error Status’, and ‘Job Warning’ are assigned to the display region Rn1 of the normal page template Tn. Also, message types ‘Local Error’, ‘Device Warning’, and ‘Jam’ are assigned to the display region Rn2. Message types ‘User Instruction’ and ‘Operation Warning’ are assigned to the display region Rn3. On the other hand, the message types ‘Job Error’, ‘Notice Error’, ‘Job In Progress’, ‘Non Error Status’, ‘Jam’ and ‘User Instruction’ are assigned to the display region Rs1 of the simple page template Ts. The message types ‘Job Warning’, ‘Local Error’, ‘Device Warning’, and ‘Operation Warning’ are assigned to the display region Rs2.

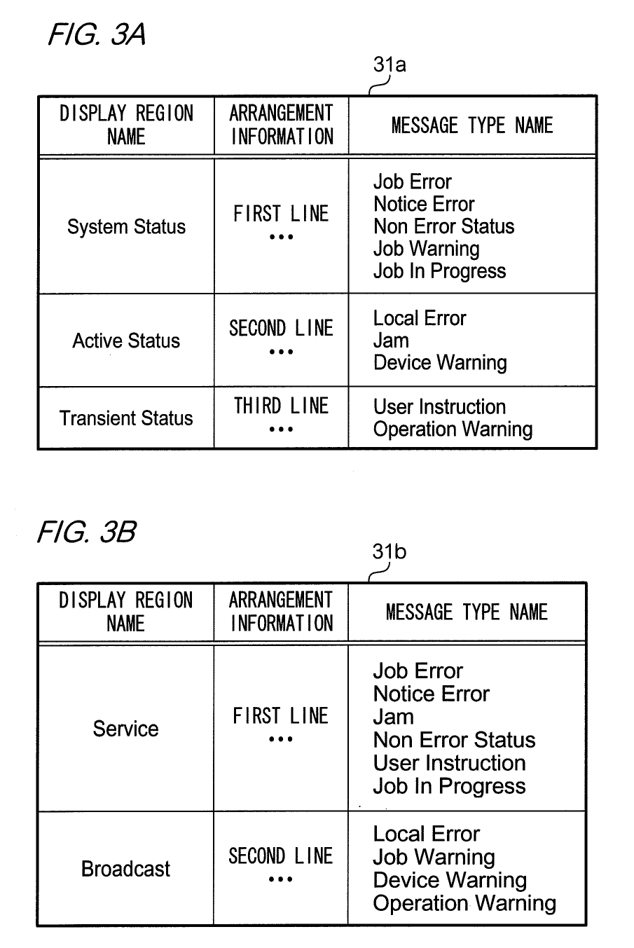

Next is a description of the table 31 that is stored in the storage unit 13. A table 31 is provided for each of the above page templates, and indicates the correspondence of the display regions and message types shown in FIG. 2. That is, the table 31 includes correspondence information that indicates the correspondence between each display region in which a message is displayed in the display operation unit 15 and the type of message displayed in that display region. FIG. 3A shows an example of a table 31a that corresponds to the above normal page template Tn, and FIG. 3B shows an example of a table 31b that corresponds to the above simple page template Ts. The number, arrangement, and size of the display regions differ between the tables 31a and 31b. As shown in FIGS. 3A and 3B, in the tables 31a and 31b, a ‘display region name’, ‘arrangement information’, and ‘message type name’ are associated. The ‘display region name’ is the name of a display region of the above page template. The ‘arrangement information’ indicates the arrangement and size of the display region. The ‘message type name’ is the name of the message type to which the message displayed in the display region belongs.

Next is a description of the priority information 32 stored in the storage unit 13. FIG. 4 shows an example of the priority information 32. As shown in FIG. 4, in the priority information 32, a ‘message type name’ is associated with a ‘priority’. The ‘message type name’ is the same sort of message type name as in the above table 31. In FIG. 4, ‘Local Error’ is the name of a message type to which belongs a message that informs that a service is aborted, or some or all functions cannot be provided, due to an apparatus failure. ‘Job Error’ is the name of a message type to which belongs a message that informs that processing is interrupted or stopped. ‘Notice Error’ is the name of a message type to which belongs a message that indicates a reason that processing has been stopped or a reason that a service cannot be provided. ‘Job Warning’ is the name of a message type to which belongs a message that informs that there is no trouble with processing, but processing was completed with settings other than those instructed by the user. ‘Device Warning’ is the name of a message type to which belongs a message that gives a warning related to the apparatus, such as a warning related to consumable goods. ‘Jam’ is the name of a message type to which belongs a message that informs that there is a problem related to paper transport, such as a paper jam. ‘Non Error Status’ is the name of a message type to which belongs a message that notifies that there are no service errors. ‘User Instruction’ is the name of a message type to which belongs a message prompting the user for operation, a message requesting that the user perform a specific operation, or a message that informs the user of an operating result. ‘Job In Progress’ is the name of a message type to which belongs a message that informs of a processing execution status. ‘Operation Warning’ is the name of a message type to which belongs a message that gives a warning related to operation. ‘Priority’ indicates a priority related to display of the message type. In the example in FIG. 4, ‘L6’ is the highest priority, with priority decreasing in the order ‘L5’, ‘L4’, ‘L3’, ‘L2’, ‘L1’. For example, in the priority information 32, the message type name ‘Local Error’ is associated with the priority ‘L6’. This indicates that the message type ‘Local Error’ has the highest priority. As described above, because a message that informs that a service is aborted or some or all functions cannot be provided, due to an apparatus failure, belongs to the message type ‘Local Error’, the message type ‘Local Error’ has the highest priority.

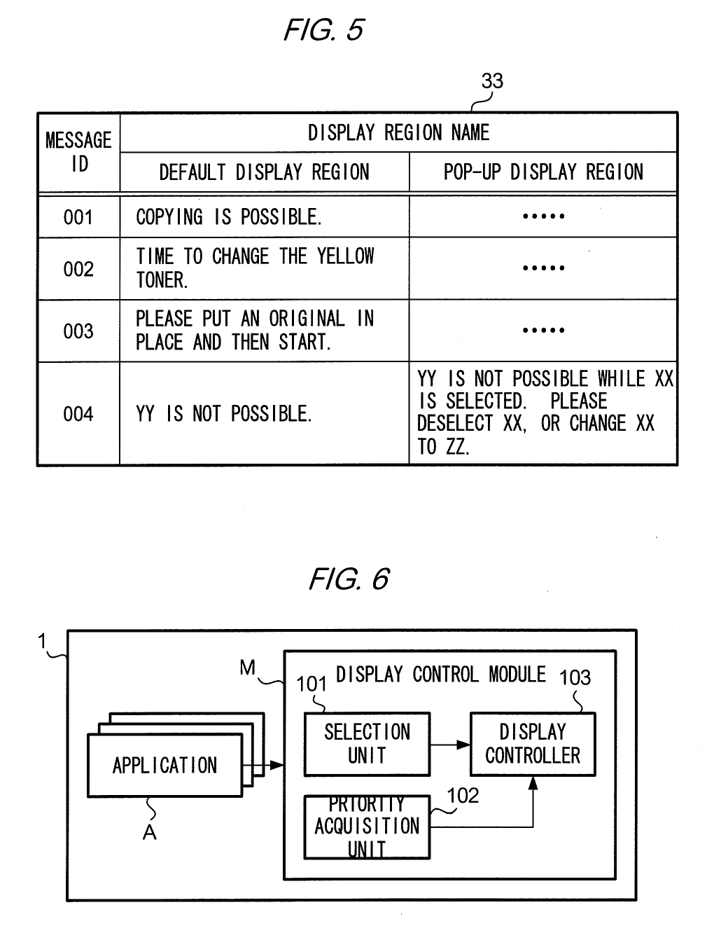

Next is a description of the message DB 33 stored in the storage unit 13. FIG. 5 shows an example of the message DB 33. As shown in FIG. 5, in the message DB 33, a ‘message ID’, a ‘display region name’, and message main text are associated. The ‘message ID’ is information that identifies a message. The ‘display region name’ indicates a location where the message is displayed. The ‘display region name’ includes a ‘default display region’ and a ‘pop-up display region’. The ‘default display region’ indicates a display location that corresponds to the display region in the above page template. The ‘pop-up display region’ indicates a display location when pop-up display of the message is displayed. For example, in this message DB33, for the message ID ‘004’, a message ‘YY is not possible.’ is associated with the ‘default display region’, and a message ‘YY is not possible while XX is selected. Please deselect XX, or change XX to ZZ.’ is associated with the ‘pop-up display region’. This indicates that when message display is requested by designating the message ID ‘004’, the message ‘YY is not possible.’ is displayed when displaying in the display region of the above page template, and the message ‘YY is not possible while XX is selected. Please deselect XX, or change XX to ZZ.’ is displayed when pop-up display is performed.

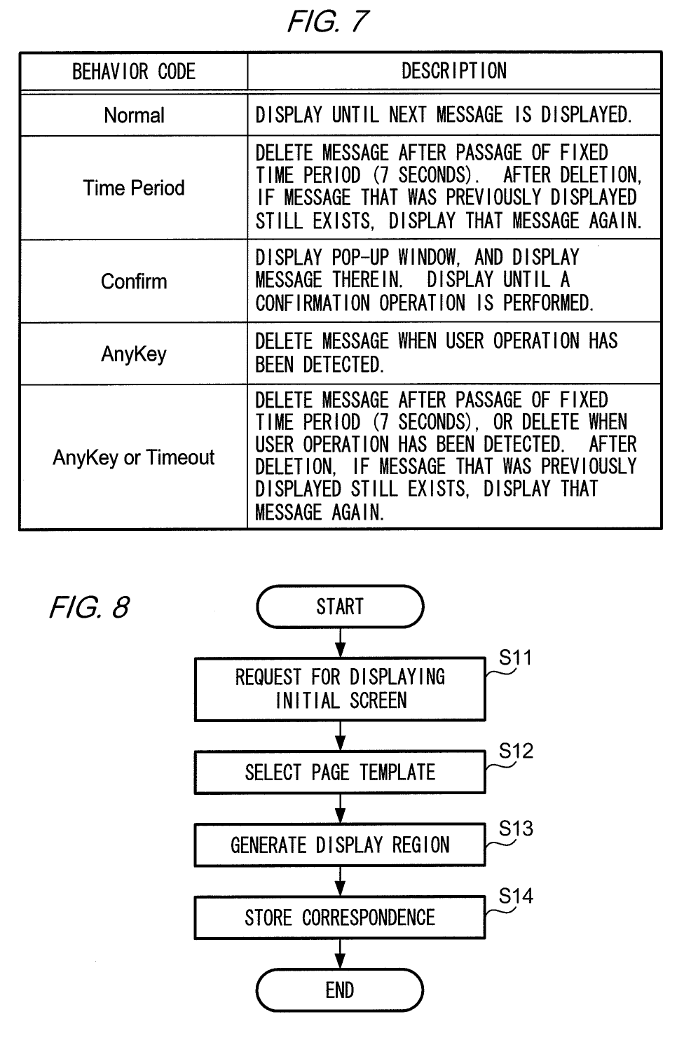

Next is a description of functions of the image-forming apparatus 1. The image-forming apparatus 1 realizes various functions by the CPU 11 executing various programs. Here, among the functions of the image-forming apparatus 1, functionality that is characteristic of the present invention will be described. FIG. 6 shows the functional configuration of the image-forming apparatus 1. As shown in FIG. 6, the image-forming apparatus 1 functions as an application A and a display control module M. The application A performs various screen and message display requests to the display control module M. For example, when performing a message display request, the application A generates additional information of the message requested to be displayed, and provides this additional information to the display control module M. A unit of additional information includes a message ID, a message type name, and a behavior code. FIG. 7 illustrates examples of such a behavior code. For example, a behavior code ‘Normal’ in FIG. 7 is information that instructs behavior of continuing to display the message until a next message is displayed. A behavior code ‘Time Period’ is information that instructs behavior of periodically deleting the message, and after deletion, if a message previously displayed still exists, displaying that message again. A behavior code ‘Confirm’ is information that instructs behavior of displaying a message in a pop-up window, and continuing display until a confirmation operation is performed. A behavior code ‘AnyKey’ is information that instructs behavior of deleting the message when user operation has been detected. A behavior code ‘AnyKey or Timeout’ is information that instructs behavior of deleting when a fixed time period has passed, or deleting when user operation has been detected, and after deletion, if a message previously displayed still exists, displaying that message again.

The display control module M, as shown in FIG. 6, has a selection unit 101, a priority acquisition unit 102, and a display controller 103, and displays a screen or message for which display has been requested by the application A in the display operation unit 15. The selection unit 101 is a selection unit that selects a table 31 from among the multiple tables 31 that are stored in the storage unit 13. The priority acquisition unit 102 is a priority acquisition unit that acquires a priority related to display of the message for which display has been requested by the application A. The display controller 103 is a display controller that, when display of a message is requested by the application A, performs control to designate the display region corresponding to the type of that message whose display has been requested based on the selected table 31 selected by the selection unit 101, and display that message for which display has been requested in the designated display region. Also, when a single display region has been designated as the display destination of multiple messages, the display controller 103 performs control to display, in the designated display region, the message whose priority acquired by the priority acquisition unit 102 is the highest among the multiple messages.

Operation

Next is a description of operation of the image-forming apparatus 1. Here, among operations of the image-forming apparatus 1, message display control, which is a characteristic portion of the present invention, will be described.

First, an initialization process performed when a power supply of the image-forming apparatus 1 has been turned on will be described. FIG. 8 is a flowchart that shows the initialization process. First, the CPU 11 performs an initialization screen display request by the application A (Step S11). At this time, the page template may be designated by the application A. Here, a case is assumed in which the normal page template Tn has been designated by the application A. Next, the CPU 11 selects a page template (Step S12). In this example, the normal page template Tn has been designated by the application A, so the normal page template Tn is selected. When a page template is not designated by the application A, a page template is selected based on the page template information stored in the ROM 21.

Next, the CPU 11 interprets the selected page template, and displays the initialization screen in the display operation unit 15. At this time, the CPU 11 generates a display region based on this page template (Step S13). FIG. 9 shows an initialization screen displayed at this time. As shown in FIG. 9, at the upper edge of this initialization screen, the display region Rn1 with the name ‘System Status’, the display region Rn2 with the name ‘Active Status’, and the display region Rn3 with the name ‘Transient Status’ are generated. In this initialization screen, no message is displayed in any of the display regions Rn1 to Rn3, so that the display regions Rn1 to Rn3 are blank. Also, although not shown in FIG. 9, an image that includes various GUI (Graphical User Interface) parts is disposed in a display region other than the display regions Rn1 to Rn3. Next, the CPU 11 selects the table 31 corresponding to the page template selected in Step S12 from among the tables 31 stored in the storage unit 13. That is, the CPU 11 selects a table 31 from among the multiple tables 31 stored in the storage unit 13. Then, the CPU 11 reads out the selected table 31 to the RAM 22, and stores the correspondence of the display region and the message type (Step S14). In this example, the normal page template Tn has been selected in Step S12, so the table 31a shown in FIG. 3A is read out from the storage unit 13, and stored in the RAM 22. Afterward the initialization process is ended, and the CPU 11 enters a standby state.

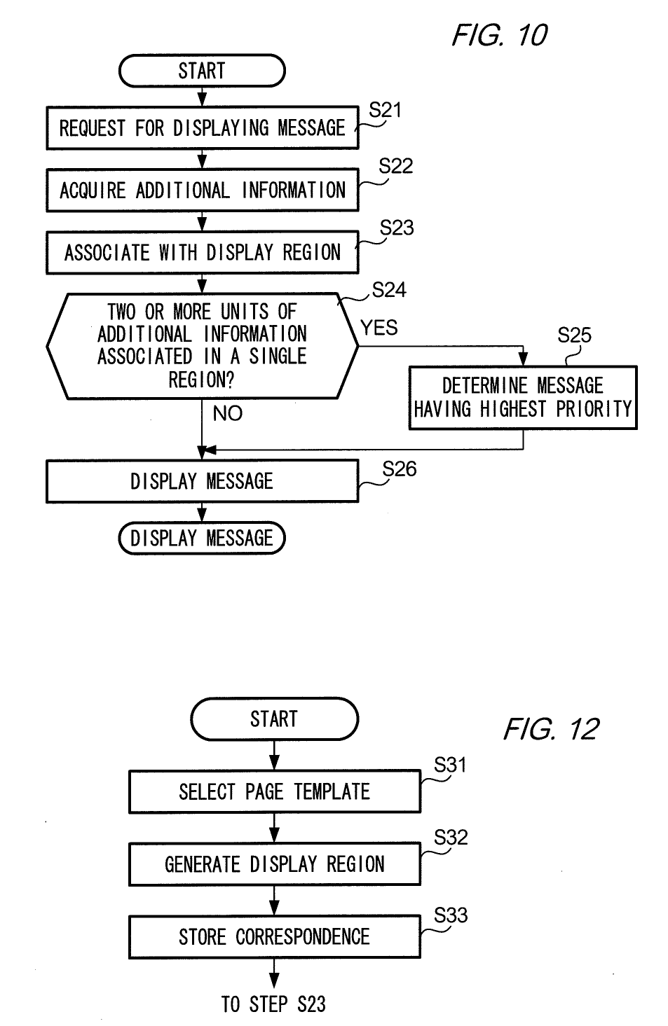

Next is a description of a message display process performed when there has been a message display request. FIG. 10 is a flowchart that shows the message display process. First, the CPU 11 performs a message display request by the application A (Step S21). Specifically, as described above, the CPU 11 generates additional information of the message requested to be displayed by the application A. Here, a case is assumed in which additional information m1 that includes the message ID ‘001’, the message type name ‘Non Error Status’, and the behavior code ‘Normal’; additional information m2 that includes the message ID ‘002’, the message type name ‘Device Warning’, and the behavior code ‘Normal’; and additional information m3 that includes the message ID ‘003’, the message type name ‘User Instruction’, and the behavior code ‘Normal’ are generated. Next, the CPU 11 performs the below process by the display control module M.

First, the CPU 11 acquires the additional information that has been generated by the application A (Step S22). In this example, the above additional information m1 to m3 is acquired. Next, the CPU 11 associates the acquired additional information with a display region based on the table 31 stored in the RAM 22 (Step S23). That is, when message display is requested, the CPU 11 designates the display region corresponding to the type of that message whose display has been requested based on the table 31 selected as described above. Specifically, the CPU 11 first designates the display region name associated with the message type name included in the acquired additional information in the table 31 of the RAM 22. Then, the CPU 11 associates the acquired additional information and the display region of the designated display region name. When the behavior code ‘Confirm’ that instructs behavior of pop-up display is included in the additional information, the process in Step S23 is skipped. In this example, as described above, the message type name ‘Non Error Status’ is included in the additional information m1. In this case, the display region name ‘System Status’ that has been associated with the message type name ‘Non Error Status’ in the table 31a shown in FIG. 3A is designated. Also, the additional information m1 is associated with the display region Rn1 having the name ‘System Status’. Similarly, because the message type ‘Device Warning’ is included in the additional information m2, the display region name ‘Active Status’ in the table 31a shown in FIG. 3A is designated, and the additional information m2 is associated with the display region Rn2 having the name ‘Active Status’. Also, because the message type ‘User Instruction’ is included in the additional information m3, the display region name ‘Transient Status’ in the table 31a shown in FIG. 3A is designated, and the additional information m3 is associated with the display region Rn3 having the name ‘Transient Status’.

Next, the CPU 11 determines whether or not two or more units of additional information are associated with a single display region (Step S24). In this example, a single unit of additional information is associated with each of the display regions Rn1 to Rn3, so the CPU 11 determines that two or more units of additional information are not associated with a single display region (Step S24: NO). In this case, the CPU 11 first reads out the message corresponding to the additional information acquired in Step S22 from the message DB 33 stored in the storage unit 13. At this time, if the behavior code included in the additional information does not instruct behavior of pop-up display, the CPU 11 reads out the message associated with the ‘message ID’ and the ‘default display region’ included in the additional information from the message DB 33, and if the behavior code included in the additional information does instruct behavior of pop-up display, the CPU 11 reads out the message associated with the ‘message ID’ and the ‘pop-up display region’ included in the additional information from the message DB 33. In this example, the message ID ‘001’ and the behavior code ‘Normal’ are included in the additional information m1. In this case, a message ‘Copying is possible.’ that has been associated with the message ID ‘001’ and ‘default display region’ is read out from the message DB 33 shown in FIG. 5. Similarly, because the message ID ‘002’ and the behavior code ‘Normal’ are included in the additional information m2, a message ‘Time to change the yellow toner.’ is read out from the message DB 33 shown in FIG. 5. Also, because the message ID ‘003’ and the behavior code ‘Normal’ are included in the additional information m3, a message ‘Please put an original in place and then start.’ is read out from the message DB 33 shown in FIG. 5. Next, the CPU 11 displays the message read out from the message DB 33 in the display region associated in above Step S23 (Step S26). That is, the CPU 11 performs control to display the message requested to be displayed in the display region designated as described above. In a case where a behavior code that instructs behavior of performing pop-up display is included in the additional information, the CPU 11 displays a pop-up window in the display operation unit 15, and displays the message that has been read out from the message DB 33 in this pop-up window.

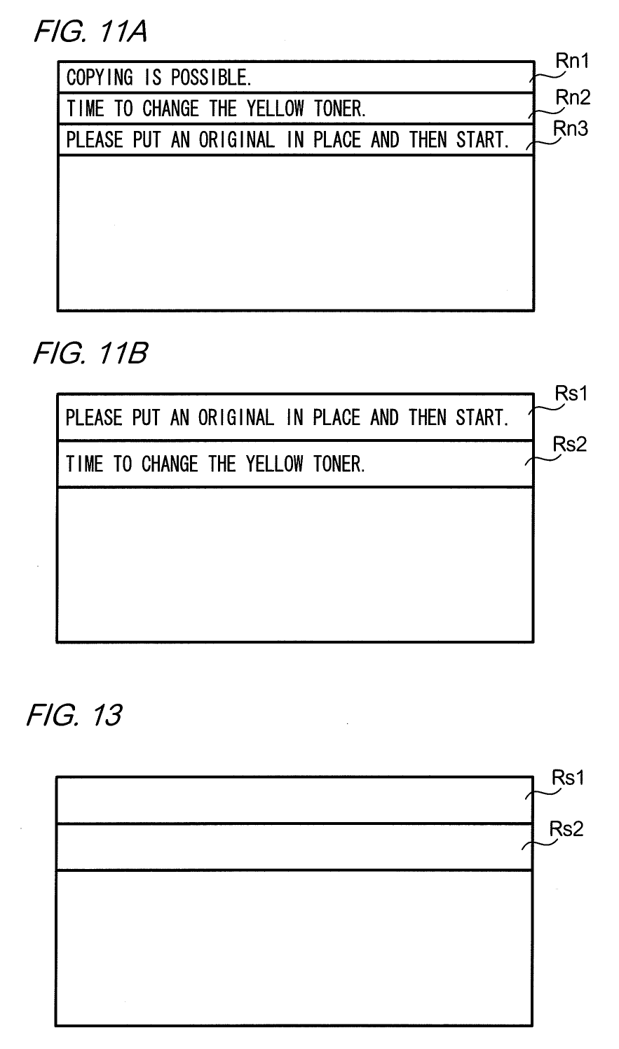

FIG. 11A shows the messages displayed at this time. As shown in FIG. 11A, the message ‘Copying is possible.’ corresponding to the message ID ‘001’ is displayed in the display region Rn1. The message ‘Time to change the yellow toner.’ corresponding to the message ID ‘002’ is displayed in the display region Rn2. The message ‘Please put an original in place and then start.’ corresponding to the message ID ‘003’ is displayed in the display region Rn3.

Next is a description of a switching process performed when page template switching has been instructed by a user operation. FIG. 12 is a flowchart that shows the switching process. Here, a case is assumed in which when the messages shown in FIG. 11A are displayed, the display operation unit 15 has been operated by the user and thus switching from the normal page template Tn to the simple page template Ts has been instructed. First, the CPU 11 selects the page template that has been instructed by the user operation (Step S31). In this example, the simple page template Ts is selected. Next, the CPU 11 cancels the display region in the display operation unit 15, and then, as in above Step S13, generates a display region based on the page template selected in Step S31 (Step S32). FIG. 13 shows the display region created at this time. As shown in FIG. 13, here, a display region Rs1 with the name ‘Service’ and a display region Rs2 with the name ‘Broadcast’ are generated. Here, no message is displayed in either of the display regions Rs1 and Rs2, so that the display regions Rs1 and Rs2 are blank. Next, as in above Step S14, the CPU 11 reads out the table 31 corresponding to the page template selected in Step S31 from the storage unit 13 to the RAM 22, and stores the correspondence of the display region and the message type (Step S33). In this example, the simple page template Ts is selected in Step S31, so the table 31b shown in FIG. 3B is read out from the storage unit 13 and stored in the RAM 22.

Then, the process in Step S33 is ended, and the CPU 11 proceeds to above Step S23. At this time, in Step S23, the message type name ‘Non Error Status’ of the additional information m1 is associated with the display region name ‘Service’ in the table 31b shown in FIG. 3B, so the additional information m1 is associated with the display region Rs1 having the name ‘Service’. Similarly, the message type name ‘Device Warning’ of the additional information m2 is associated with the display region name ‘Broadcast’ in the table 31b shown in FIG. 3B, so the additional information m2 is associated with the display region Rs2 having the name ‘Broadcast’. Also, the message type name ‘User Instruction’ of the additional information m3 is associated with the display region name ‘Service’ in the table 31b shown in FIG. 3B, so the additional information m3 is associated with the display region Rs1 having the name ‘Service’.

Next, in Step S24, the additional information m1 and the additional information m3 are associated with the display region Rs1, so the CPU 11 determines that two or more units of additional information are associated with a single display region (Step S24: YES). In this case, the CPU 11 first acquires the priorities of those units of additional information from the priority information 32 stored in the storage unit 13. That is, the CPU 11 acquires priority related to display of the messages for which display has been requested. Next, the CPU 11 determines the unit of additional information having the highest priority among those units of additional information (Step S25). In this example, the message type name ‘Non Error Status’ is included in the additional information m1, so a priority ‘L1’ associated with the message type name ‘Non Error Status’ is acquired from the priority information 32 shown in FIG. 4. Also, the message type name ‘User Instruction’ is included in the additional information m3, so a priority ‘L3’ associated with the message type name ‘User Instruction’ is acquired from the priority information 32 shown in FIG. 4. In this case, the priority ‘L3’ is highest, so the additional information m3 is determined to be the additional information having the highest priority.

Then, in Step S26, the message according to the additional information acquired in Step S22 is displayed in the display region associated in above Step S23. At this time, a message corresponding to the additional information determined in above Step S25 is displayed in the display region with which two or more units of additional information are associated. That is, when a single display region has been designated as the display destination of multiple messages, the CPU 11 performs control to display the message having the highest acquired priority among the multiple messages in the display region that has been designated as described above. FIG. 11B shows the messages displayed at this time. As shown in FIG. 11B, the message ‘Please put an original in place and then start.’ corresponding to the message ID ‘003’ is displayed in the display region Rs1. The message ‘Time to change the yellow toner.’ corresponding to the message ID ‘002’ is displayed in the display region Rs2. The message ‘Copying is possible.’ corresponding to the message ID ‘001’ has low priority and therefore is not displayed.

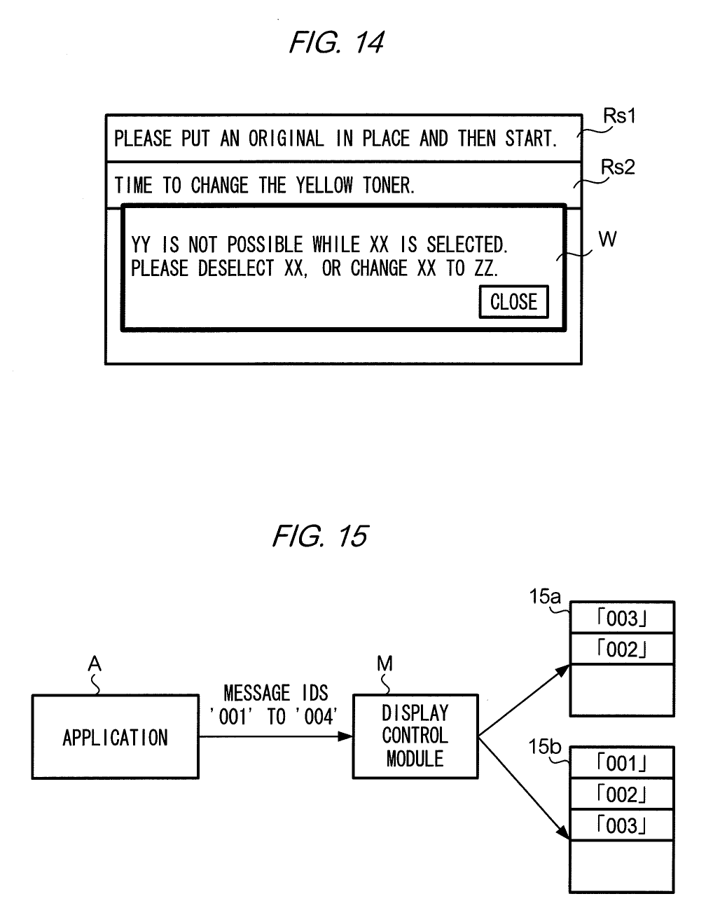

Next, in above Step S21, a case is assumed in which additional information m4 that includes the message ID ‘004’, the message type ‘Notice Error’, and the behavior code ‘Confirm’ is generated by the application A, and a message display request is performed. In this case, in the next Step S22, the additional information m4 is acquired. Then, in Step S23, because the behavior code ‘Confirm’ that instructs behavior of pop-up display is included in the additional information m4, the process is skipped and the routine proceeds to Step S24. Next, in Steps S24 and S25, processing similar to that described above is performed. Then, in Step S26, because the behavior code ‘Confirm’ that instructs behavior of pop-up display is included in the additional information m4, in the message DB 33 shown in FIG. 5, the message ‘YY is not possible while XX is selected. Please deselect XX, or change XX to ZZ.’ that has been associated with the message ID ‘004’ and the ‘pop-up display region’ is read out. Next, a pop-up window is displayed in the display operation unit 15, and the message read out from the message DB 33 is displayed in this pop-up window. FIG. 14 shows the message displayed at this time. As shown in FIG. 14, a pop-up window W is displayed in the display operation unit 15, and the message ‘YY is not possible while XX is selected. Please deselect XX, or change XX to ZZ.’ corresponding to the message ID ‘004’ is displayed in the pop-up window W.

### MODIFIED EXAMPLES

The foregoing is a description of an exemplary embodiment, but the content of this exemplary embodiment can be modified as described below. Also, the respective modified examples below may be appropriately combined.

### Modified Example 1

In the above exemplary embodiment, when two or more units of additional information are associated with a single display region, the message with the highest priority is determined to be the message displayed in that display region, but the message to be displayed may also be determined without using priority. For example, it is possible to identify the additional information that is requested most recently and display a message corresponding to the determined additional information. In this case, it is not necessary for the priority information 32 to be stored in the storage unit 13.

### Modified Example 2

In the above exemplary embodiment, the page template may be selected, for example, in the following manner.

The page template may be selected according to the size of the display region of the display operation unit 15. In this case, the CPU 11 acquires the display size of the display region of the display operation unit 15, and selects the normal page template Tn if that display size is larger than a threshold value, and selects the simple page template Ts if the display size is not larger than the threshold value. The reason for such selection is that, since the character size is larger for the simple page template Ts, the characters will be more easily viewed when using the simple page template Ts if the size of the display region of the display operation unit 15 is small.

Also, the page template may be selected according to the application A. In this case, the CPU 11 determines the application A to be executed, and selects a predetermined page template for the determined application A. The reason for such selection is that in some circumstances, when displaying a message displayed by a particular application A, the normal page template Tn is appropriate, but when displaying a message displayed by another application A, the simple page template Ts is appropriate.

Also, a page template corresponding to the user who uses the image-forming apparatus 1 may be selected. In this case, the image-forming apparatus 1 is provided with a user authentication function, and the CPU 11 selects a predetermined page template for an authenticated user. At this time, when, for example, the user desires display having a large character size, it is sufficient that the simple page template Ts is set as the page template that is ordinarily used.

Also, a page template may be selected according to the language of a message. In this case, the CPU 11 acquires language information included in the additional information, and selects the simple page template Ts if the language that language information indicates is Chinese, Japanese, or the like, and selects the normal page template Tn if the indicated language is English or the like. The reason for this sort of selection is that when the message language is Chinese or Japanese, the characters will be more easily viewed using the simple page template Ts having a large character size.

In other words, the CPU 11 performs selection of the table 31 based on at least any one of the size of the display region of the display operation unit 15, the content of an operation performed using the display operation unit 15, the size of characters that constitute a message, the language of those characters, or a display format predetermined for each user of that apparatus.

Also, the image-forming apparatus 1 may be provided with a first display operation unit 15a and a second display operation unit 15b with different display region sizes. In this case, the CPU 11 uses the display control module M to select the page template corresponding to the first display operation unit 15a and the page template corresponding to the second display operation unit 15b, and causes both the first display operation unit 15a and the second display operation unit 15b to display a message corresponding to the selected page template. Here, a case is assumed in which the above simple page template Ts has been selected as the page template corresponding to the first display operation unit 15a with a smaller display region, and the above normal page template Tn has been selected as the page template corresponding to the second display operation unit 15b with a larger display region. FIG. 15 shows how, as in the above exemplary embodiment, messages are displayed in the first display operation unit 15a and the second display operation unit 15b when a message display request for the message IDs ‘001’ to ‘004’ has been performed by the application A. In this case, in the first display operation unit 15a, as in the case where the simple page template Ts has been selected in the above exemplary embodiment, the messages of the message IDs ‘002’ and ‘003’ are displayed, and in the second display operation unit 15b, as in the case where the normal page template Tn has been selected in the above exemplary embodiment, the messages of the message IDs ‘001’ to ‘003’ are displayed. In this way, shared content (in this example, the messages of the message IDs ‘002’ and ‘003’) is displayed in a displayable range in the first display operation unit 15a and the second display operation unit 15b by the display control module M. Also, in this case, the CPU 11 that executes the application A, as in the above exemplary embodiment, may only create additional information that indicates the content of the messages and perform a message display request, and is not required to perform the request based on the size of the display region. That is, it is sufficient that a procedure to create additional information that indicates the content of the messages and performs a display request for those messages is described in the application A; it is not required to describe a procedure to perform the request based on the size of the display region. Also, even when there are multiple display operation units to be message display destinations, the CPU 11 that executes the application A is not required to perform a message display request multiple times; it is sufficient to perform a message display request only once. That is, even when there are multiple display operation units to be message display destinations, it is sufficient that a procedure to perform a message display request only once is described.

### Modified Example 3

In the above exemplary embodiment, when two or more units of additional information are associated with a single display region, the message with the next highest priority may be displayed when the message with the highest priority has been deleted. That is, when the message with the highest priority is displayed in a display region and then there is a request to not display that message, the CPU 11 may perform a control to display the message with the next highest priority among the multiple messages in this display region.

### Modified Example 4

In the above exemplary embodiment, the upper limit of the number of characters disposed in a single display region is fixed. Therefore, when the number of characters in a message is greater than that upper limit, the message may not fit in the display region. In such a case, the message may be displayed using an abbreviated expression. It is conceivable that this abbreviated expression, for example, has the symbols ‘ . . . ’ at the end of the message. Furthermore, in this case, a pop-up window may be displayed, and all of the message characters may be displayed in that pop-up window.

### Modified Example 5

In the above exemplary embodiment, an example was described in which two page templates are prepared, but three or more page templates may also be prepared. Further, the number of display regions, the arrangement, the size, and so forth of the page templates are not limited to the example shown in FIG. 2. For example, four or more display regions may be provided, and the display regions may be provided at the lower edge of the display region.

### Modified Example 6

In the above exemplary embodiment, the display operation unit 15 received user operation, but the way of receiving user operation is not limited to this. For example, a keyboard or mouse may be used, or the user's voice may be analyzed to determine instruction content of the user's voice.

### Modified Example 7

The content of the table 31 or the priority information 32 stored in the storage unit 13 in the above exemplary embodiment may be changed. This change may be performed by a user operation, or the CPU 11 may perform this change according to a program.

### Modified Example 8

In the above exemplary embodiment, the message main text itself (text information) may be included instead of a message ID in the additional information. In this case, it is not absolutely necessary for the message DB 33 to be stored in the storage unit 13.

Also, it may be that only a message ID and a behavior code are included in the additional information, without inclusion of a message type name. In this case, a table in which the correspondence of the message ID and the message type are described is stored in the storage unit 13, and the CPU 11 that executes the display control module M specifies a message type based on this table.

Also, it may be that a table in which a message ID itself is associated as a message type name with the display region name and priority is stored, and the CPU 11 that executes the display control module M specifies the display region and the priority based on this table. In this case, it is not absolutely necessary for the table 31 and the priority information 32 to be stored in the storage unit 13.

### Modified Example 9

In the above exemplary embodiment, among the screens that are displayed in the display operation unit 15 is a screen that receives an instruction related to image formation. Thus, when a screen that receives an instruction related to image formation has been displayed in the display operation unit 15, the image output unit 19 performs image formation according to an instruction received by this screen. That is, the present invention can also be designated as an image-forming apparatus.

Also, the display control apparatus of the present invention may be applied to an apparatus such as a computer apparatus or a portable telephone.

### Modified Example 10

In the above exemplary embodiment, each of the respective operations performed by the image-forming apparatus 1 may be realized by a single hardware resource, or may be realized by cooperative operation of multiple hardware resources. Also, the processes executed by the CPU 11 may be realized by a single program, or may be realized by a combination of multiple programs. Further, a program executed by the CPU 11 can be supplied in a form stored on a storage medium readable by a computer apparatus, such as a magnetic storage medium like a magnetic tape or a magnetic disk, an optical storage medium like an optical disk, a magneto-optical storage medium, a semiconductor memory, or the like. Also, this program can be downloaded via a communications network such as the Internet.

The foregoing description of the embodiments of the present invention is provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display control apparatus, comprising:
a memory that stores a plurality of units of correspondence information each indicative of a correspondence between a display region of a display for displaying a message, and a type of the message, each of the plurality of units of correspondence information having a different condition of at least one of a number, an arrangement, and a size of the display region;
a selection unit that selects a unit of correspondence information stored in the memory; and
a display controller that, when display of a message is requested, designates a display region corresponding to the type of the message requested to be displayed based on the correspondence information selected by the selection unit, and displays the message requested to be displayed in the designated display region.

2. The display control apparatus according to claim 1, further comprising a priority acquisition unit that acquires a display priority for the message requested to be displayed,
wherein when a single display region is designated for displaying a plurality of messages, the display controller displays the message having the highest priority acquired by the priority acquisition unit from among the plurality of messages in the designated display region.

3. The display control apparatus according to claim 2, wherein upon receipt of a request for deleting the message with the highest priority being displayed in the display region, the display controller displays a message having the next highest priority from among the plurality of messages in the display region.

4. The display control apparatus according to claim 1, wherein the selection unit selects the correspondence information based on at least any one of sizes of the plurality of display regions, a user's input via an operation unit, a size of characters of the message, a language of the characters, or a display format predetermined for the user.

5. The display control apparatus according to claim 1, wherein:
a plurality of the displays are provided;
the selection unit selects a plurality of units of correspondence information corresponding to the respective displays from among a plurality of units of correspondence information stored in the memory; and
when display of messages in the plurality of displays is requested, the display controller designates, in each of the plurality of the displays, the display region corresponding to the type of the message requested to be displayed based on the correspondence information corresponding to the display selected by the selection unit, and displays the messages requested to be displayed in the respective display region.

6. An image-forming apparatus, comprising:
a memory that stores a plurality of units of correspondence information each indicative of a correspondence between a display region of a display for displaying a message, and a type of the message, each of the plurality of units of correspondence information having a different condition of at least one of a number, an arrangement, and a size of the display region;
a selection unit that selects a unit of correspondence information stored in the memory;
a display controller that, when display of a message is requested, designates a display region corresponding to the type of the message requested to be displayed based on the correspondence information selected by the selection unit, and displays the message requested to be displayed in the designated display region; and
an image-forming unit that forms an image according to a user's instruction input via the display.

7. A storing medium storing a computer program for causing a computer to execute:
selecting a unit of correspondence information stored in the memory, the memory storing a plurality of units of correspondence information each indicative of a correspondence between a display region of a display for displaying a message, and a type of the message, each of the plurality of units of correspondence information having a different condition of at least one of a number, an arrangement, and a size of the display region; and
in response to receipt of a request for display of a message, designating a display region corresponding to the type of the message requested to be displayed based on the correspondence information selected by the selection unit, and displaying the message requested to be displayed in the designated display region.
